(19) United States
(12) Patent Application Publication
(10) Pub. No.: US 2007/0052597 A1
(43) Pub. Date: Mar. 8, 2007

(54) Telecommunications appliance having a receiving antenna

(76) Inventor: Roman Piekarz, Mielec (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/366,812

(22) Filed: Mar. 3, 2006

(30) Foreign Application Priority Data
Sep. 3, 2005 (DE) 10 2005 011 627.2

(51) Int. Cl. H01Q 1/24

(52) U.S. Cl. 343/702

(57) ABSTRACT

A telecommunications appliance having at least one display (13) which is arranged in a housing (14), is mounted on a holder and is held such that it can be positioned flexibly, starting from an attachment point, by means of a plastically deformable metallic rod (4), and having a receiving antenna which is connected to an antenna input of the housing (14), is designed in order to reduce the complexity for connecting cables such that the metallic rod (4) is electrically connected to the antenna input and forms at least a part of the receiving antenna.

The invention relates to a telecommunications appliance having at least one display which is arranged in a housing, is mounted on a holder and is held such that it can be positioned flexibly, starting from an attachment point, by means of a plastically deformable metallic rod, and having a receiving antenna which is connected to an antenna input of the housing.

It is known for telecommunications appliances which are designed to receive broadcast radio signals, in particular frequency-modulated signals in the VHF range, to be mounted on a so-called swan-neck holder in order that different operators can see the appliance display well, and can control it easily.

One preferred field of application for such telecommunications appliances is for installation in the interior of motor vehicles. The swan-neck attachment on the one hand allows the display to be seen well by the driver, while on the other hand the appliance is also adjusted such that it can be operated easily by the front-seat passenger. The swan-neck holder is particularly suitable for a navigation appliance which is equipped with a broadcast radio receiving section, in order to receive traffic messages, which are scrambled in a standardized manner within the broadcast radio signal, and to process them for navigation. It is thus known for the navigation appliance to be connected to a VHF receiving antenna on the motor vehicle. Since, furthermore, a supply voltage and a received signal from a satellite antenna (GPS) antenna must be supplied to the navigation appliance, a plurality of supply lines are required to the navigation appliance which is mounted on the swan neck, which are visually distracting and furthermore can also interfere with the handling of other appliances in the area of the navigation appliance that is fitted.

The present invention is thus based on the object of designing a telecommunications appliance of the type mentioned initially such that the connecting cable complexity can be reduced.

According to the invention, in order to achieve this object, a telecommunications appliance of the type mentioned initially is characterized in that the metallic rod is electrically connected to the antenna input and forms at least part of the receiving antenna.

Thus, according to the invention, the metallic rod which forms the swan-neck attachment is at the same time used as a receiving antenna. It has been found that this allows sufficiently good reception of broadcast radio signals which are transmitting traffic messages via the TMC (traffic message channel) in digitized form. These traffic messages are decoded in the navigation appliance and, if desired, are taken into account in the calculation of the route to the destination. For reception optimization, it may be expedient to provide the metallic rod with a matching coil, in order to allow optimized matching to the transmitted radio signals.

It is particularly expedient if the swan-neck attachment is provided in a manner known per se with a suction cup on a vehicle window pane, since broadcast radio signals can be received with a minimum of interference and without being shielded, or being shielded only to a minor extent, by metal parts of the bodywork, in the area of the vehicle window panes.

The metallic rod which forms the essence of the swan-neck attachment may be in the form of a solid or hollow-tubular rod composed of a suitable metallic alloy which ensures the required plastic deformation. However, it is also possible for the rod to be in the form of a wire which is wound in a helical hollow-cylindrical shape, to provide the plastic adjustment capability.

It is expedient for the metallic rod to be surrounded by a flexible tube composed of an electrically insulating material.

In one preferred embodiment, the metallic rod is connected to a plug having a plug housing for holding the housing of the display, preferably via a ball joint. In this case, the plug is electrically connected to the metallic rod, preferably via a sprung sliding contact, through the ball joint.

The matching coil for the antenna which is formed by the metallic rod is preferably formed by a coil whose inductance cannot be varied in series with an adjustable coil. The coil which cannot be varied may expediently be in the form of an SMD (surface mounted device).

A power supply cable and—in the case of a navigation appliance—a connecting cable for connection to a satellite navigation antenna are preferably connected to the plug housing of the holder, onto which the housing of the display can be plugged. In the case of a navigation appliance, the housing of the display contains a microprocessor and the software for route calculation, and the data replayed from a digital map, as a basis for route calculations.

The invention will be explained in more detail in the following text with reference to one exemplary embodiment, which is illustrated in the drawing, in which:

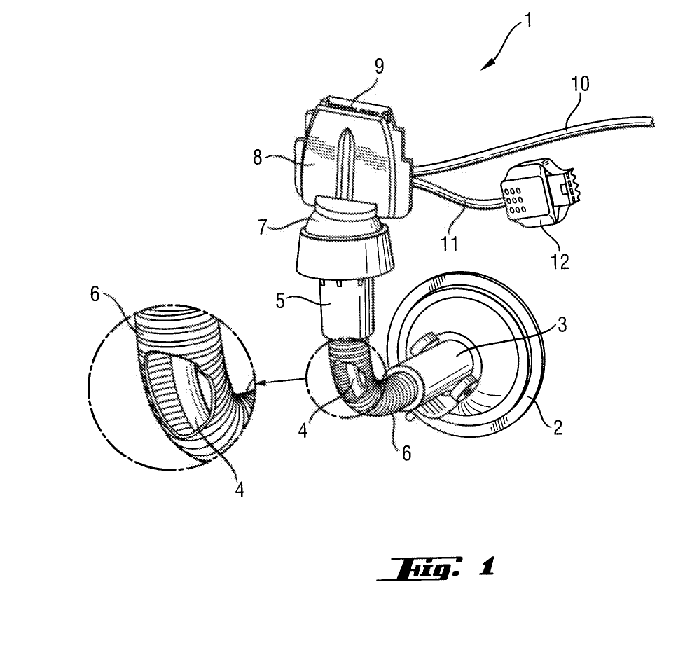

FIG. 1 shows a schematic illustration of a holder which is formed with a plastically deformable metallic rod, which forms a receiving antenna,

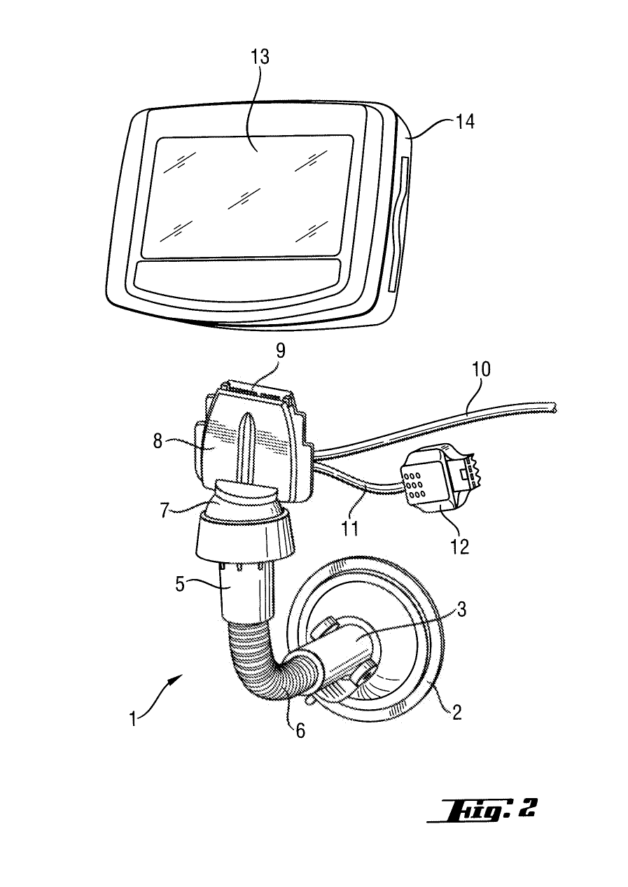

FIG. 2 shows a perspective illustration of the holder and of a separate display, and

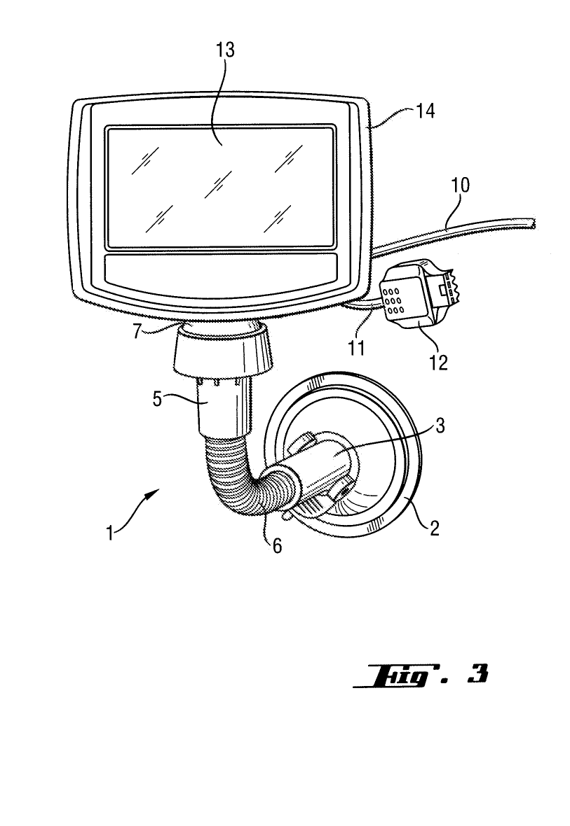

FIG. 3 shows a perspective view of the display plugged onto the holder.

FIG. 1 shows a holder 1 which can be fitted by means of a suction cup 2 to an attachment point, preferably to an outside window pane of a motor vehicle. A sleeve 3, in which one end of a metallic rod 4 is secured, is mounted on the suction cup 2. The other end of the metallic rod 4, which is bent through about 90°, is secured in a housing part 5 in the form of a sleeve. The metallic rod is surrounded by a flexible tube 6 composed of a plastic material, between the sleeve 3 and the housing part 5 which is in the form of a sleeve.

The housing part 5 which is in the form of a sleeve forms, on the its upper face, a bearing pan for a ball joint 7, to which a plug housing 8 of a plug 9 is fitted. The plug 9 is electrically connected to the metallic rod 4 such that the electrical contact is maintained even during adjustment of the ball joint 7. For this purpose, the plug 9 can be connected to the metallic rod 4 via a sprung sliding contact.

As can also be seen from FIG. 1, a supply cable 10 and a connecting cable piece 11 (which is fitted at its free end with an antenna plug 12 for connection to a satellite navigation antenna) open into the plug housing 8 and are connected to the plug 9.

As can be seen from FIG. 2, a housing 14, which is provided with a display 13, of a navigation appliance can be plugged onto the plug housing 8 of the plug 9. FIG. 3 shows the installed navigation appliance after being plugged onto the plug 9.

The receiving antenna which is formed by the metallic rod and can be matched by means of a matching coil to the frequencies to be received allows reception of traffic messages via the traffic message channel (TMC), without any need to provide a connection to an external antenna for this purpose. According to the invention, there is therefore no need for a connecting cable to a VHF antenna.

1. Telecommunications appliance having at least one display (13) which is arranged in a housing (14), is mounted on a holder and is held such that it can be positioned flexibly, starting from an attachment point, by means of a plastically deformable metallic rod (4), and having a receiving antenna which is connected to an antenna input of the housing (14), wherein the metallic rod (4) is electrically connected to the antenna input and forms at least a part of the receiving antenna.

2. The telecommunications appliance as claimed in claim 1, wherein the metallic rod (4) is surrounded by a flexible tube (6) composed of electrically insulating material.

3. The telecommunications appliance as claimed in claim 1, wherein the metallic rod (4) is held at 20 the attachment point by means of a suction cup (2).

4. The telecommunications appliance as claimed in claim 1, wherein the metallic rod (4) is connected to a plug (9), which has a plug housing (8), in order to hold the housing (14) of the display (13).

5. The telecommunications appliance as claimed in claim 4, wherein the plug (9) is connected to the metallic rod (4) via a ball joint (7).

6. The telecommunications appliance as claimed in claim 5, wherein the plug (9) is electrically connected to the metallic rod (4) through the ball joint (7).

7. The telecommunications appliance as claimed in claim 6, wherein the plug (9) is electrically connected to the metallic rod (4) by means of a sprung sliding contact.

8. The telecommunications appliance as claimed in claim 4, wherein the metallic rod (4) is connected to the plug (9) via a matching coil.

9. The telecommunications appliance as claimed in claim 8, wherein the matching coil is formed by a coil whose inductance cannot be varied in series with an adjustable coil.

10. The telecommunications appliance as claimed in claim 9, wherein the coil which cannot be varied is in the form of an SMD.

11. The telecommunications appliance as claimed in claim 4, wherein a power supply cable (10) is connected to the plug housing (8).

12. The telecommunications appliance as claimed in claim 1, wherein the metallic rod (4) is in the form of a solid rod composed of a plastically deformable alloy.

13. The telecommunications appliance as claimed in claim 1, wherein the metallic rod (4) is formed from a wire which is wound in a helical hollow-cylindrical shape.

14. The telecommunications appliance as claimed in claim 1, wherein the appliance, as a navigation appliance, is provided with a plug connection (12) for a satellite navigation antenna.

15. The telecommunications appliance as claimed in claim 14, wherein the plug connection (12) for the satellite navigation antenna opens into the plug housing (8).

16. The telecommunications appliance as claimed in claim 15, wherein the plug connection (12) is fitted to a flexible cable end (11).
